(19) United States
(12) Patent Application Publication
(10) Pub. No.: US 2024/0072328 A1
(43) Pub. Date: Feb. 29, 2024

(54) Heat Transfer Member Capable of Preventing Propagation of Thermal Runaway and Battery Module Including The Same

(71) Applicant: SK On Co., Ltd., Seoul (KR)

(72) Inventors: Jeong Woo HAN, Daejeon (KR); Ji San KIM, Daejeon (KR); Bon Seok KU, Daejeon (KR); Hae Ryong JEON, Daejeon (KR)

(21) Appl. No.: 18/239,222

(22) Filed: Aug. 29, 2023

(30) Foreign Application Priority Data
Aug. 30, 2022 (KR) 10-2022-0108828

(51) Int. Cl. H01M 10/653; H01M 10/613; H01M 10/647; H01M 10/658

(52) U.S. Cl. CPC H01M 10/653; H01M 10/613; H01M 10/647; H01M 10/658

(57) ABSTRACT

The present disclosure relates to a heat transfer member capable of preventing propagation of thermal runaway and a battery module including the same, and more particularly, to a heat transfer member capable of preventing propagation of thermal runaway in which heat or flame is propagated due to ignition or the like of at least one battery cell in a battery module, and a battery module including the same. According to the present embodiment, a heat transfer member provided in contact with a cooling member in a battery module or a stack composed of a plurality of battery cells includes a thermally expandable material having a thermal expansion initiation temperature of 90 to 150° C.

### CROSS-REFERENCE TO RELATED APPLICATIONS

This patent document claims the priority and benefits of Korean Patent Application No. 10-2022-0108828, filed on Aug. 30, 2022, in the Korean Intellectual Property Office, the disclosure of which is incorporated herein by reference in its entirety.

### TECHNICAL FIELD

The following disclosure relates to a heat transfer member capable of preventing propagation of thermal runaway and a battery module including the same, and more particularly, to a heat transfer member capable of preventing propagation of thermal runaway in which heat or flame is propagated due to ignition or the like of at least one battery cell in a battery module, and a battery module including the same.

### BACKGROUND

In recent years, as a measure to the global warming issue, the demand for eco-friendly technologies is rapidly increasing. In particular, as the technical demand for electric vehicles and energy storage system (ESS) that do not emit exhaust gases increases, battery cells are in the spotlight. A plurality of battery cells used in electric vehicles are accommodated in a battery case made of metal or plastic for physical/chemical protection and are provided in an EV system in the form of modules. Generally, the EV system includes a cooling system to cool heat generated from cells during operation.

When assembling battery cells with a battery case in order to more efficiently dissipate heat generated from a plurality of battery cells to a cooling system, a heat transfer member made of a thermal interface material (TIM) such as thermal adhesive or thermal pad is usually provided between the battery cell and the battery case or between the battery case and the cooling member. In this way, the heat transfer member fills an empty space between the battery cell and the battery case or between the battery case and the battery cooling member. Accordingly, a heat transfer path of the battery case-heat transfer member-cooling member or the battery cell-heat transfer member-battery case is formed to increase thermal conductivity, and components in the module may be structurally combined through adhesion. However, when the heat transfer member is provided between the battery cell and the battery case or between the battery case and the cooling member as described above, the following two problems exist.

First, when heat or flame is generated due to ignition of at least one battery cell, the heat quickly spreads to the heat transfer path formed to dissipate the heat previously generated in the battery cell, so there is a problem that the thermal runaway propagates from battery cell to battery cell or from battery module to battery module. Second, when recycling battery cells whose lifespan is over, it is difficult to separate the battery cells due to the heat transfer member that structurally combines the components in the battery module through the adhesion, etc., and when separating the battery cells forcibly, the battery cells are damaged and thus there is a risk of an accident.

### SUMMARY

An embodiment of the present disclosure is directed to providing a heat transfer member capable of preventing propagation of thermal runaway and a battery module including the same.

Another embodiment of the present disclosure is directed to increasing recycling efficiency of a battery cell/battery module by facilitating separation of battery cells from a battery module when recycling a battery cell whose lifespan is over.

In one general aspect, a heat transfer member provided in contact with a cooling member in a battery module or a stack composed of a plurality of battery cells includes a thermally expandable material having a thermal expansion initiation temperature of 90 to 150° C.

The thermally expandable material may be a thermally expandable capsule that includes an outer shell material made of a thermoplastic resin and an internal filler filled inside the outer shell material and vaporized by heating.

The outer shell material of the thermally expandable capsule may include a nitrile-based polymer.

The internal filler of the thermally expandable capsule may include a C3-C24 volatile saturated hydrocarbon.

A thickness of the outer shell material of the thermally expandable capsule may be 0.1 to 30 μm.

The thermal expandable material may be included in 3 to 20% by volume compared to a total volume of the heat transfer member.

The heat transfer member may include the thermally expandable material in a substrate of at least one selected from the group consisting of an acrylic resin, a urethane resin, an olefin resin, a silicone resin, and an epoxy resin.

In another general aspect, a battery module includes: a stack composed of a plurality of battery cells; a heat transfer member provided on one surface of the stack; and a battery case accommodating the stack and the heat transfer member, in which the heat transfer member includes a thermally expandable material having a thermal expansion initiation temperature of 90 to 150° C.

The thermally expandable material may be a thermally expandable capsule that includes an outer shell material made of a thermoplastic resin and an internal filler filled in the outer shell material and vaporized by heating.

The outer shell material of the thermally expandable capsule may include a nitrile-based polymer.

The internal filler of the thermally expandable capsule may include a C3-C24 volatile saturated hydrocarbon.

The thermal expandable material may be included in 3 to 20% by volume compared to a total volume of the heat transfer member.

The battery module may further include: a cooling member provided on one side of the battery case; and a heat transfer member interposed between the cooling member and the battery case.

The battery module may further include one or more heat insulating members between the plurality of battery cells.

In still another general aspect, a battery module includes: a stack composed of a plurality of battery cells; a battery case covering the other surfaces of the stack except for one surface of the stack; a heat transfer member provided on one surface of the stack; and a cooling member provided on one side of the heat transfer member, in which the heat transfer member includes a thermally expandable material having a thermal expansion initiation temperature of 90 to 150° C.

The thermally expandable material may be a thermally expandable capsule that includes an outer shell material made of a thermoplastic resin and an internal filler filled in the outer shell material and vaporized by heating.

The outer shell material of the thermally expandable capsule may include a nitrile-based polymer.

The internal filler of the thermally expandable capsule may include a C3-C24 volatile saturated hydrocarbon.

The thermal expandable material may be included in 3 to 20% by volume compared to a total volume of the heat transfer member.

The battery module may further include one or more heat insulating members between the plurality of battery cells.

### BRIEF DESCRIPTION OF THE DRAWINGS

FIG. 1 is a diagram illustrating a thermally expandable capsule, which is one of thermally expandable materials according to an embodiment of the present disclosure.

FIG. 2 is a diagram illustrating a battery module according to the present disclosure.

FIGS. 3A to 3C are diagrams for describing a mechanism for preventing propagation of thermal runaway of a battery module according to the present disclosure. FIG. 3A is a diagram illustrating a heat source of thermal runaway. FIG. 3B is a diagram illustrating a battery module during the thermal runaway. FIG. 3C is a diagram illustrating a mechanism for preventing propagation of thermal runaway of a battery module.

FIG. 4 is a diagram for describing a mechanism for separating battery cells whose lifespan is over from a battery module according to the present disclosure.

FIG. 5A is a diagram illustrating section II-II′ of the battery module according to an embodiment of the present disclosure illustrated in FIG. 2. FIG. 5B is a diagram illustrating section II-II′ of a battery module according to another embodiment of the present disclosure illustrated in FIG. 2. FIG. 5C is a diagram illustrating section II-II′ of a battery module according to another embodiment of the present disclosure illustrated in FIG. 2.

FIG. 6A is a diagram illustrating section II-II′ of a battery module according to another embodiment in which the battery modules are stacked in a direction perpendicular to a direction in which the battery modules are stacked in FIG. 5B. FIG. 6B is a diagram illustrating a II-II′ section of a battery module according to another embodiment in which the battery modules are stacked in a direction perpendicular to a direction in which the battery modules are stacked in FIG. 5C.

FIG. 7A is a diagram illustrating the stacked form of the battery modules according to an embodiment of the present disclosure. FIG. 7B is a diagram illustrating the stacked form of the battery modules according to another embodiment of the present disclosure.

### DETAILED DESCRIPTION OF MAIN ELEMENTS

1: Battery module
10: Stack composed of plurality of battery cells
11: Battery cell
20: Battery case
30: Heat transfer member
300: Thermally expandable material
40: Cooling member

### DETAILED DESCRIPTION OF EMBODIMENTS

Various advantages and features of the present disclosure and methods accomplishing them will become apparent from the following description of embodiments with reference to the accompanying drawings. However, the present disclosure is not limited to exemplary embodiments to be described below, but may be implemented in various different forms, these embodiments will be provided only in order to make the present disclosure complete and allow those skilled in the art to completely recognize the scope of the present disclosure, and the present disclosure will be defined by the scope of the claims. Hereinafter, exemplary embodiments of the present disclosure will be described in detail with reference to the accompanying drawings. Regardless of the drawings, the same reference numbers refer to the same components.

Unless defined otherwise, all terms (including technical and scientific terms) used in the present specification have the same meaning as meanings commonly understood by those skilled in the art to which the present disclosure pertains. Throughout the present specification, unless described to the contrary, “including” any component will be understood to imply the inclusion of other elements rather than the exclusion of other elements. In addition, a singular form includes a plural form unless specially described in the text.

In the present disclosure, when a structure such as a layer, a film, a region, a plate, and a member is said to be on “one surface” or “one side” of another structure, there may be not only the case where it is in direct contact with another structure, but also the case where there is another structure therebetween.

In the present disclosure, a “thermal expansion initiation temperature” may be measured using a thermomechanical analyzer (TMA). In an embodiment of the present disclosure, the thermal expansion initiation temperature may be a temperature at which a displacement begins to be observed in a vertical direction of a pressing terminal during isothermal treatment when 250 μg of thermally expandable capsule is placed in a cylindrical aluminum container having a diameter of 7 mm and a depth of 1 mm and temperature rising/isothermal treatment is repeated from 80° C. to 220° C. with a force of 0.1 N applied from above. In this case, the temperature rising condition may be performed within 1 minute at 5° C./min, and the isothermal condition may be performed for 1 to 5 minutes.

The heat transfer member in the battery module may be provided in contact with a cooling member or a battery cell to fill an empty space between the battery case and the cooling member or the battery cell and the battery case. Accordingly, a heat transfer path of battery case-heat transfer member-cooling member or battery cell-heat transfer member-battery case may be formed to increase thermal conductivity, and components in the module may be structurally combined by adhesion.

However, when the heat transfer member is provided between the battery cell and the battery case or between the battery case and the cooling member as described above, the following two problems exist. First, when heat or flame is generated due to ignition of at least one battery cell, the heat quickly spreads to the heat transfer path formed to dissipate the heat previously generated in the battery cell, so there is a problem that the thermal runaway propagates from battery cell to battery cell or from battery module to battery module. Second, when recycling battery cells whose lifespan is over, it is difficult to separate the battery cells due to the heat transfer member that structurally combines the components in the battery module through the adhesion, etc., and when separating the battery cells forcibly, the battery cells are damaged and thus there is a risk of an accident.

In order to solve these problems, according to an embodiment of the present disclosure, in the heat transfer member provided in contact with the cooling member or the battery cell in the battery module, the heat transfer member including the thermally expandable material having the thermal expansion initiation temperature of 90 to 150° C. is provided.

Hereinafter, first, each configuration of the battery module will be described.

Any electrochemical element may be used as the battery cell. A non-limiting example of the electrochemical device may include a lithium secondary battery.

The battery case may be provided to protect at least one outer surface of a stack composed of a plurality of battery cells to protect the stack from external impact or foreign substances and reinforce strength and rigidity of the battery module, thereby improving assembling performance. The battery case may be applied to all known battery cases in the field of battery module technology, but according to a non-limiting example, the battery case may be a battery case made of aluminum (Al) material.

According to one example, the cooling member may include a metal plate including at least one of copper, silver, and aluminum having very high thermal conductivity in order to dissipate heat generated from the battery cell. According to an example, the cooling member may be a plate made of aluminum in order to have predetermined thermal conductivity and at the same time secure mechanical rigidity of the battery module. However, since the material and shape of the cooling member described above are exemplary, the cooling member is not limited thereto, and all the cooling members known in the field of battery module technology may be applied.

A non-limiting example of the cooling member may include a cooling member having a cooling passage, and the cooling passage is formed between a battery case on the outside and a metal plate on the inside, and heat generated from the battery cell may be dissipated while coolant moving along the cooling passage.

From the viewpoint that the cooling member dissipates heat generated from a stack, according to one example, the thermal conductivity of part or all of the cooling member may be 10 W/(m·K) or more, 30 W/(m·K) or more, or 50 W/(m·K) or more.

In an embodiment, the heat transfer member may be provided in contact with the cooling member or stack in the battery module. The heat transfer member is provided between the stack and the battery case or between the battery case and the cooling member to increase adhesion between the components and may be made of a material with an excellent heat dissipation effect that dissipates heat generated from the stack to the battery case or cooling member. According to a non-limiting example, the heat transfer member may use at least one of a material having excellent thermal conductivity, a thermal interface material (TIM), a heat dissipating adhesive, and a heat dissipating pad known in the field of battery module technology.

According to an embodiment, a substrate of the heat transfer member may be a substrate of at least one selected from the group consisting of an acrylic resin, a urethane resin, an olefin resin, a silicone resin, and an epoxy resin, according to a non-limiting example.

In a specific embodiment, the heat transfer member may optionally further include a curing agent. According to a non-limiting example, the curing agent may be at least one curing agent selected from the group consisting of a siloxane compound, an isocyanate compound, and an amine compound.

In a specific embodiment, the heat transfer member may optionally further include an inorganic filler to improve the thermal conductivity. According to a non-limiting example, the inorganic filler may be an inorganic filler that is at least one selected from the group consisting of alumina (Al₂O₃), aluminum nitride (AlN), boron nitride (BN), silicon nitride (Si₃N₄), silicon carbide (SiC), beryllium oxide (BeO), zinc oxide (ZnO), aluminum hydroxide (Al(OH)₃), and boehmite (AlO(OH)). The inorganic filler may have a thermal conductivity of 1 W/(m·K) or more, or 5 W/(m·K) or more, or 10 W/(m·K) or more, but is not particularly limited.

According to an embodiment of the present disclosure, the heat transfer member may include a thermally expandable material. The thermally expandable material may have a thermal expansion initiation temperature of 90° C. or higher, 100° C. or higher, 110° C. or higher, 150° C. or lower, or values between the above values, and specifically, may be 90 to 150° C., or 100 to 150° C., or 110 to 150° C. According to the present disclosure, the thermally expandable material thermally expands when the thermal runaway occurs in the battery module to cause cracking/breakage in the heat transfer member, thereby breaking a previously formed heat transfer path and suppressing the propagation of the thermal runaway in the battery module.

The thermally expandable material according to the present disclosure is a material having a thermal expansion initiation temperature of 90 to 150° C., or 100 to 150° C., or 110 to 150° C., and any material that may thermally expand at the thermal expansion initiation temperature during the thermal runaway to cause cracking or breakage of the heat transfer member may be used, and the thermally expandable material is not limited to materials of a specific structure or material.

However, according to an embodiment of the present disclosure, the thermally expandable material may be a thermally expandable capsule that includes an outer shell material made of a thermoplastic resin and an internal filler filled inside the outer shell material and vaporized by heating. The internal filler in the thermally expandable capsule vaporizes as the temperature rises, and as a result, the thermally expandable capsule thermally expands.

According to one example, the outer shell material of the thermally expandable capsule may include a nitrile-based polymer.

According to one example, the internal filler of the thermally expandable capsule may include a C3-C24 volatile saturated hydrocarbon. Examples of the C3-C24 volatile saturated hydrocarbon may include propane, butane, pentane, hexane, heptane, octane, nonan, decane, isobutane, isopentane, isohexane, isoheptane, isooctane, isononane, isodecane, cyclopropane, cyclobutane, cyclopentane, cyclohexane, cycloheptane, cyclooctane, neopentane, dodecane, isododecane, cyclotridecane, hexylcyclohexane, tridecane, tetradecane, pentadecane, hexadecane, heptadecane, octadecane, nanodecane, isotridecane, 4-methyldodecane, isotetradecane, isopentadecane, isohexadecane, 2,2,4,4,6,8,8-heptamethyl nonane, isoheptadecane, isooctadecane, isonanodecane, 2,6,10,14-tetramethylpentadecane, cyclotridecane, heptyl cyclohexane, n-octyl cyclohexane, cyclopentadecane, nonyl cyclohexane, decyl cyclohexane, pentadecyl cyclohexane, hexadecyl cyclohexane, heptadecyl cyclohexane, octadecyl cyclohexane, and the like, but is not particularly limited. As a specific example of the internal filler, an internal filler of a hydrocarbon mixture obtained by dissolving gaseous hydrocarbons in liquid hydrocarbons at room temperature may be used.

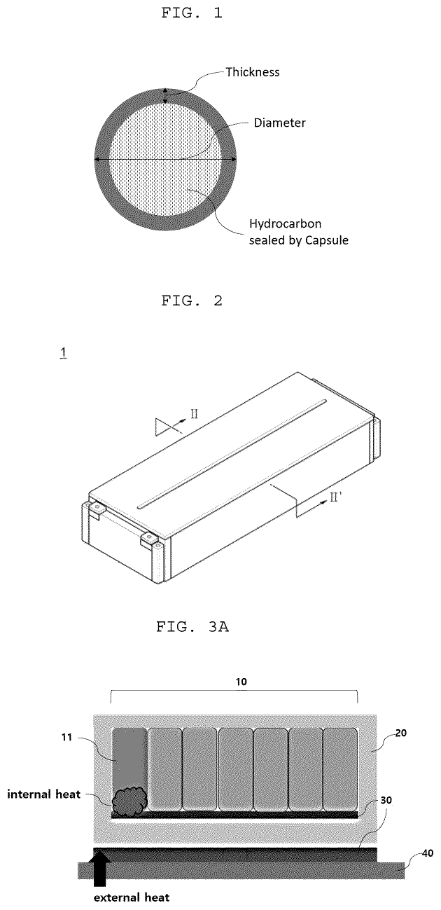

Referring to FIG. 1, an average diameter of a thermally expandable capsule, which is one of thermally expandable materials 300 according to an embodiment, may be 1 μm or more, 100 μm or less, 80 μm or less, 60 μm or less, or values between the above values, and specifically, may be 1 to 100 μm, or 1 to 80 μm, or 1 to 60 μm. According to an embodiment, the thickness of the outer shell material of the thermally expandable capsule may be 0.1 μm or more, 1 μm or more, 30 μm or less, 20 μm or less, or values between the above values, and specifically 0.1 to 30 μm, or 0.1 μm to 20 μm, 1 to 30 μm, or 1 to 20 μm.

In an embodiment, the thermally expandable material including the thermally expandable capsule may be included in 3 vol % or more, 4 vol % or more, 5 vol % or more, 20 vol % or less, 18 vol % or less, 15 vol % or less based on the total volume of the heat transfer member, or values between the above numbers. In a specific embodiment, the thermally expandable material may be 3 to 20 vol % or 4 to 18 vol % based on the total volume of the heat transfer member, and in a more specific embodiment, may be 5 to 15 vol %. When thermal runaway occurs in the content range of the thermally expandable member of the embodiment, by effectively inducing the cracking/breakage of the heat transfer member due to the thermal expansion to break the previously formed heat transfer path, the sufficient thermal conductivity of the heat transfer member may be secured by suppressing a phenomenon in which thermal resistance increases due to the excessively thermally expandable material while more suppressing the propagation of the thermal runaway in the battery module, but is not particularly limited.

In an embodiment, the heat transfer member may sufficiently dissipate heat generated from the stack during the normal operation of the battery module, and according to one example, the thermal conductivity of the heat transfer member including the thermally expandable material is 0.5 to 5 W/(m·K), but is not limited thereto. Considering the thermal conductivity range, the thermally expandable material may be appropriately included in the heat transfer member, and is not particularly limited.

FIG. 2 is a diagram illustrating a battery module 1 according to an embodiment. The battery module according to the present disclosure may include all configurations of a general battery module known in the art unless otherwise specified, and it should be noted that the fact that detailed configurations of the battery module are not specifically illustrated in the drawings does not exclude configurations not illustrated.

In addition, although a prismatic battery module is illustrated in FIG. 2, embodiments of the present disclosure are not limited to a specific type or form of battery module, and it is to be noted that each component in a battery module of various types or shapes, such as a pouch type, a cylindrical shape, or a prismatic shape, satisfies the relative positional relationship described below, and the interaction of each component is made the same and extends to all types and forms of battery modules capable of preventing the propagation of thermal runaway.

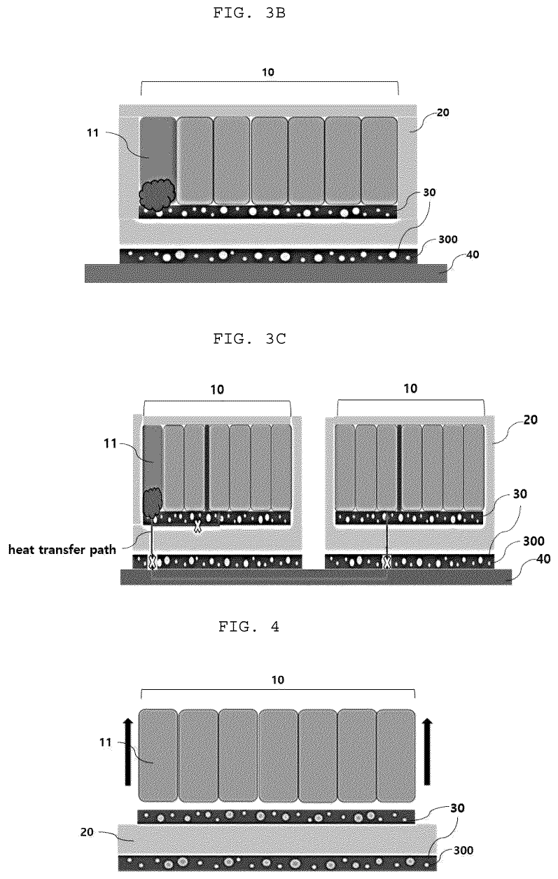

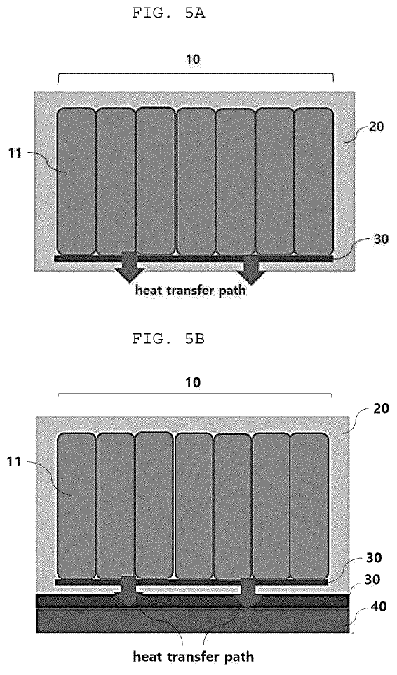

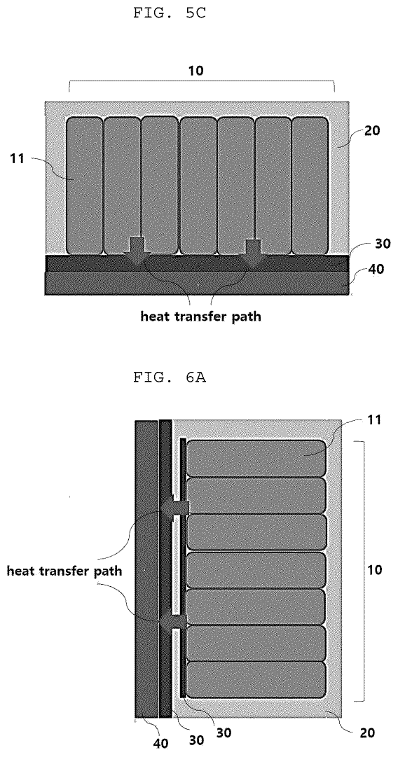

In order to describe the principle of preventing the propagation of thermal runaway of the heat transfer member according to the present disclosure, it will be described with reference to FIGS. 3A to 3C attached. FIGS. 3A to 3C correspond to sections II-II′ 10 of the battery module according to FIG. 2.

FIG. 3A is a diagram illustrating a heat source of thermal runaway. According to FIG. 3A, at least one battery cell 11 in the battery module may be ignited as a heat source of the thermal runaway. The cause of the ignition may be, for example, defects of a battery cell, an abnormal operation of the battery cell, or the like. Another heat source of the thermal runaway may be heat transferred from the outside to the battery module. For example, it may be heat transferred from equipment, instruments or other mechanical components of vehicles on which the battery module is mounted.

FIG. 3B is a diagram illustrating a battery module during the thermal runaway. Since the thermally expandable material 300 does not thermally expand between about −40 and 80° C., which is the usual management temperature of the EV system, the thermally expandable material 300 is maintained forming the heat transfer path, but as illustrated in FIG. 3B, when the temperature around the battery cell exceeds 80° C. and rises rapidly to about 100 to 130° C. during the thermal runaway in at least one battery cell 11, the thermally expandable material 300 starts to thermally expand to cause the cracking or breakage of the heat transfer member 30.

As a result, as illustrated in FIG. 3C attached, it is possible to suppress the propagation of the thermal runaway from the battery cell 11 in which the thermal runaway occurs to the normally operating battery cell 11 by breaking the existing heat transfer path existing between battery cells or between battery modules or the propagation of the thermal runaway from the battery module 10 including the battery cell 11 in which the thermal runaway occurs to the normally operating battery module 10.

In addition, the thermally expandable material 300 serves to easily separate a stack 10 whose lifespan is over from the battery module 1, thereby increasing the recycling efficiency of the battery cell/battery module. This will be described with reference to FIG. 4 attached.

As described above, the heat transfer member 30 is provided between the stack 10 and the battery case 20 or between the battery case 20 and the cooling member 40 to increase the adhesion between the respective components, thereby improving the assembling performance at the time of assembling the battery module. However, when the battery cell 11 whose lifespan is over is separated from the battery module, it is rather difficult to separate the battery cell/battery module due to the adhesion of the heat transfer member 30.

Referring to FIG. 4, according to the present disclosure, when the battery module 1 whose lifespan is over is heated to a temperature range exceeding a thermal expansion initiation temperature of the thermally expandable material 300 in the heat transfer member 30, the thermally expandable material 300 initiates thermal expansion to cause the cracking/breakage of the heat transfer member 30, so the adhesion of the heat transfer member 30 is lowered. As a result, it is possible to increase recycling efficiency of the battery cell/battery module by facilitating separation of the battery cell from the battery module through a simple means such as heating.

Hereinafter, specific examples of the battery module including the heat transfer member capable of preventing the propagation of thermal runaway according to the present disclosure will be described in detail with reference to the drawings. A description of each component of the battery module is the same as described above, and thus will be omitted for convenience.

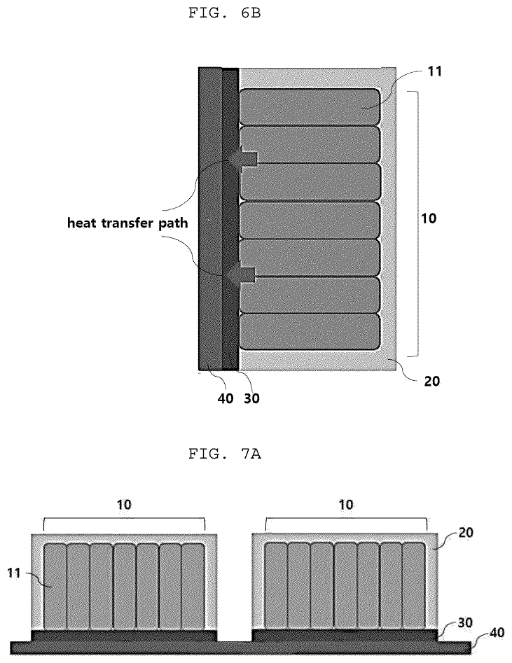

FIG. 5A is a diagram illustrating section II-II′ of the battery module according to a first embodiment of the present disclosure illustrated in FIG. 2. Referring to FIG. 5A, according to an embodiment of the present disclosure, the battery module includes the stack 10 composed of the plurality of battery cells 11, the heat transfer member 30 provided on one surface of the stack 10, and the battery case 20 accommodating the stack 10 and the heat transfer member 30, in which the heat transfer member 30 includes a thermally expandable material having a thermal expansion initiation temperature of 90 to 150° C., or 100 to 150° C., or 110 to 150° C.

According to the embodiment of FIG. 5A, the heat transfer path is formed of the stack 10-heat transfer member 30-battery case 20.

According to the above embodiment, as the thermally expandable material in the heat transfer member 30 expands during thermal runaway of at least one battery cell 11 in the stack 10, the heat transfer member 30 cracks or breaks, so the propagation of thermal runaway may be prevented by breaking the heat transfer path of the stack 10-heat transfer member 30-battery case 20.

In addition, the battery module according to an embodiment of the present disclosure may optionally further include one or more heat insulating members between the plurality of battery cells. The heat insulating member is provided between the battery cells to prevent propagation of thermal runaway to other battery cells adjacent to each other along side surfaces of the battery cell during thermal runaway of at least one battery cell.

In particular, in the battery module according to an embodiment in which the thermally expandable material is included in the heat transfer member 30 and the heat insulating member is further included, the heat transfer path of the stack 10-heat transfer member 30-battery case 20 is broken by the thermally expandable material in the heat transfer member 30 during the thermal runaway, and the heat transfer path through the heat transfer member 30 between the battery cells in the stack 10 is also broken in the same way. As a result, according to the embodiment, the thermal runaway propagating along the side surface of the battery cell is prevented by the heat insulating member, and the thermal runaway propagating along the heat transfer member 30 provided on one surface of the battery cell is prevented by the breakage of the heat transfer path by the thermally expandable material in the heat transfer member 30.

FIG. 5B is a diagram illustrating section II-II′ of a battery module according to a second embodiment of the present disclosure illustrated in FIG. 2. Referring to FIG. 5B, according to an embodiment of the present disclosure, the battery module includes the stack 10 composed of the plurality of battery cells 11, the heat transfer member 30 provided on one surface of the stack 10, and the battery case 20 accommodating the stack 10 and the heat transfer member 30, the cooling member 40 provided on one side of the battery case 20, and the heat transfer member 30 interposed between the cooling member 40 and the battery case 20, and the battery module 1 in which the heat transfer member 30 includes the thermally expandable material having the thermal expansion initiation temperature of 90 to 150° C., 100 to 150° C., or 110 to 150° C. may be provided. The battery module according to the second embodiment may further include a cooling member provided on one side of the battery case of the battery module according to the first embodiment; and the heat transfer member interposed between the cooling member and the battery case.

According to the embodiment of FIG. 5B, the heat transfer path is formed of the stack 10-heat transfer member 30-battery case 20-heat transfer member 30-cooling member 40.

When the thermally expandable material is included in the heat transfer member 30 provided between the stack 10 and the battery case 20, as the thermally expandable material in the heat transfer member 30 expands during the thermal runaway of the battery cell 11 in the stack 10, the heat transfer member 30 is cracked or broken, so the propagation of thermal runaway may be prevented by breaking the heat transfer path of the stack 10-heat transfer member 30-battery case 20.

When the thermally expandable material is included in the heat transfer member 30 provided between the battery case 20 and the cooling member 40, as the thermally expandable material in the heat transfer member 30 expands during the thermal runaway of the battery cell 11 in the stack 10, the heat transfer member 30 is cracked or broken, so the propagation of thermal runaway may be prevented by breaking the heat transfer path of the battery case 20-heat transfer member 30-cooling member 40.

According to the above embodiment, as the thermally expandable material in the heat transfer member 30 expands during thermal runaway of at least one battery cell 11 in the stack 10, the heat transfer member 30 is cracked or broken, so the propagation of thermal runaway may be prevented by breaking a series of heat transfer paths of the stack 10-heat transfer member 30-battery case 20-heat transfer member 30-cooling member 40.

In addition, the battery module according to a specific embodiment of the present disclosure may optionally further include one or more heat insulating members between the plurality of battery cells. The heat insulating member is provided between battery cell-battery cell to prevent propagation of thermal runaway to other battery cells adjacent to each other along side surfaces of the battery cell during thermal runaway of at least one battery cell.

In the battery module according to the specific embodiment, the heat transfer path of the stack 10-heat transfer member 30-battery case 20 is broken by the thermally expandable material in the heat transfer member 30 during the thermal runaway, and the heat transfer path through the heat transfer member 30 between the battery cells in the stack 10 is also broken in the same way. That is, according to the specific embodiment, the thermal runaway propagating along the side surface of the battery cell is prevented by the heat insulating member, and the thermal runaway propagating along the heat transfer member 30 provided on one surface of the battery cell is prevented by the breakage of the heat transfer path by the thermally expandable material in the heat transfer member 30, thereby further suppressing/preventing the thermal runaway phenomenon.

FIG. 5C is a diagram illustrating section II-II′ of a battery module according to a third embodiment of the present disclosure illustrated in FIG. 2. Referring to FIG. 5C, according to an embodiment of the present disclosure, the battery module includes the stack 10 composed of the plurality of battery cells 11, the battery case 20 covering the other side of the stack 10 except for one surface, the heat transfer member 30 provided on one surface of the stack 10, and the cooling member 40 provided on one side of the heat transfer member 30, in which the heat transfer member 30 includes a thermally expandable material having a thermal expansion initiation temperature of 90 to 150° C., or 100 to 150° C., or 110 to 150° C.

According to the embodiment of FIG. 5C, the heat transfer path is formed of the stack 10-heat transfer member 30-cooling member 40.

According to the above embodiment, as the thermally expandable material in the heat transfer member 30 expands during thermal runaway of at least one battery cell 11 in the stack 10, the heat transfer member 30 is cracked or broken, so the propagation of thermal runaway may be prevented by breaking the heat transfer path of the stack 10-heat transfer member 30-cooling member 40.

In addition, the battery module according to an embodiment of the present disclosure may optionally further include one or more heat insulating members between the plurality of battery cells. The heat insulating member is provided between the battery cells to prevent propagation of thermal runaway to other battery cells adjacent to each other along side surfaces of the battery cell during thermal runaway of at least one battery cell.

In particular, in the battery module according to an embodiment in which the thermally expandable material is included in the heat transfer member 30 and the heat insulating member is further included, the heat transfer path of the stack 10-heat transfer member 30-cooling member 40 is broken by the thermally expandable material in the heat transfer member 30 during the thermal runaway, and the heat transfer path through the heat transfer member 30 between the battery cells in the stack 10 is also broken in the same way. As a result, according to the embodiment, the thermal runaway propagating along the side surface of the battery cell is prevented by the heat insulating member, and the thermal runaway propagating along the heat transfer member 30 provided on one surface of the battery cell is prevented by the breakage of the heat transfer path by the thermally expandable material in the heat transfer member 30.

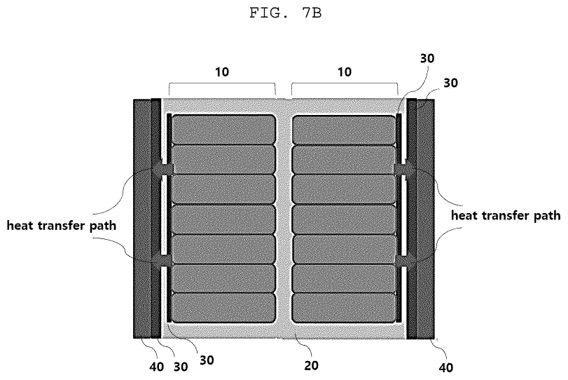

FIG. 6A is a diagram illustrating section II-II′ of a battery module according to another embodiment in which the battery modules are stacked in a direction perpendicular to a direction in which the battery modules are stacked in FIG. 5B. FIG. 6B is a diagram illustrating section II-II′ of a battery module according to another embodiment in which the battery modules are stacked in a direction perpendicular to a direction in which the battery modules are stacked in FIG. 5C.

According to FIGS. 6A and 6B, it can be seen that each battery module according to the embodiments may be stacked in a direction perpendicular to the direction in which the battery modules of FIGS. 5B and 5C are stacked.

According to the embodiment of FIG. 6A, the direction in which the battery modules are stacked is perpendicular to the direction in which the battery modules are stacked in FIG. 5B, the relative positional relationship of the stack 10, the heat transfer member 30, the battery case 20, and the cooling member 40, which are components of the battery module, is the same as that of the embodiment of FIG. 5B. As a result, the above-described interaction of components in the battery module of FIG. 5B and the mechanism for preventing the thermal runaway may also be performed in the battery module of FIG. 6A.

According to the embodiment of FIG. 6B, the direction in which the battery modules are stacked is perpendicular to the direction in which the battery modules are stacked in FIG. 5C, the relative positional relationship of the stack 10, the heat transfer member 30, the battery case 20, and the cooling member 40, which are components of the battery module, is the same as that of the embodiment of FIG. 5C. As a result, the above-described interaction of components in the battery module of FIG. 5C and the mechanism for preventing the thermal runaway may also be performed in the battery module of FIG. 6B.

FIG. 7A is a diagram illustrating the arranged form of the battery modules according to an embodiment of the present disclosure. According to the embodiment of FIG. 7A, a plurality of battery modules selected from among the above-described embodiments may be arranged and provided on the cooling member 40. When reviewing each battery module of the cooling member 40, the relative positional relationship of the stack 10, the battery case 20, the heat transfer member 30, and the cooling member 40, which are components of the battery module, is the same as that of the embodiment of FIG. 5C. As a result, the above-described interaction of components in the battery module of FIG. 5C and the mechanism for preventing the thermal runaway may also be performed in the battery modules of FIG. 6A.

However, all of the battery modules illustrated in FIG. 7A illustrates the battery modules according to the embodiment of FIG. 5C, but this is merely an example to aid understanding, and it is to be noted that one or more of the battery modules of the above-described embodiment of the present disclosure are selected and applied.

FIG. 7B is a diagram illustrating the arranged form of the battery modules according to another embodiment of the present disclosure. According to the embodiment of FIG. 7B, a plurality of battery modules selected from among the above-described embodiments may be arranged and provided on the cooling members 40 facing each other, respectively. When reviewing each battery module arranged in the cooling member 40, the relative positional relationship of the stack 10, the battery case 20, the heat transfer member 30, and the cooling member 40, which are components of the battery module, is the same as that of the embodiment of FIG. 5B. As a result, the above-described interaction of components in the battery module of FIG. 5B and the mechanism for preventing the thermal runaway may also be performed in the battery modules of FIG. 7B.

However, all of the battery modules illustrated in FIG. 7B illustrates the battery modules according to the embodiment of FIG. 5B, but this is merely an example to aid understanding, and it is to be noted that one or more of the battery modules of the above-described embodiment of the present disclosure are selected and applied.

Hereinabove, in the embodiments (FIGS. 6A and 6B) in which the battery modules are stacked in different directions and in the embodiments (FIGS. 7A and 7B) in which the battery modules are arranged in various ways, the relative positional relationship of the stack 10, the battery case 20, the heat transfer member 30, and the cooling member 40 of each battery module prepared in the above embodiments is the same as that of any one of the battery modules of FIGS. 5A to 5C, and as a result, the interaction of components in the battery module and the mechanism for preventing thermal runaway are made the same as that of any one of the battery modules of FIGS. 5A to 5C, so these embodiments may be considered to correspond to embodiments of the present disclosure.

According to the present disclosure, it is possible to dissipate heat generated from a battery cell by using a heat transfer member including a thermally expandable material to maintain a heat transfer path when a battery module operates normally. At the same time, when thermal runaway occurs in the battery module, the thermal expansion of the thermally expandable material is used to cause cracking/breakage of the heat transfer member, and thus, the previously formed heat transfer path is destroyed, thereby preventing the propagation of the thermal runaway.

According to the present disclosure, when the battery module whose lifespan is over is heated to a temperature range exceeding a thermal expansion initiation temperature of the thermally expandable material in the heat transfer member, the thermally expandable material initiates thermal expansion to cause cracking/breakage of the heat transfer member, so the adhesion of the heat transfer member is lowered. As a result, it is possible to increase recycling efficiency of the battery cell/battery module by facilitating separation of the battery cell from the battery module through a simple means such as heating.

Although the embodiments of the present disclosure have been described above, the present disclosure is not limited to the above embodiments, and various modifications and changes may be made to the disclosed embodiments and other embodiments may be made based on what is disclosed in this patent document.

What is claimed is:

1. A heat transfer member provided in contact with a cooling member in a battery module or a stack composed of a plurality of battery cells, comprising: a thermally expandable material having a thermal expansion initiation temperature of 90 to 150° C.

2. The heat transfer member of claim 1, wherein the thermally expandable material is a thermally expandable capsule that comprises a outer shell material made of a thermoplastic resin and an internal filler filled inside the outer shell material and vaporized by heating.

3. The heat transfer member of claim 2, wherein the outer shell material of the thermally expandable capsule comprises a nitrile-based polymer.

4. The heat transfer member of claim 2, wherein the internal filler of the thermally expandable capsule comprises a C3-C24 volatile saturated hydrocarbon.

5. The heat transfer member of claim 2, wherein a thickness of the outer shell material of the thermally expandable capsule is 0.1 to 30 μm.

6. The heat transfer member of claim 1, wherein the thermal expandable material is included in 3 to 20% by volume compared to a total volume of the heat transfer member.

7. The heat transfer member of claim 1, wherein the heat transfer member comprises the thermally expandable material in a substrate of at least one selected from the group consisting of an acrylic resin, a urethane resin, an olefin resin, a silicone resin, and an epoxy resin.

8. A battery module, comprising:
a stack composed of a plurality of battery cells;
a heat transfer member provided on one surface of the stack; and
a battery case accommodating the stack and the heat transfer member,
wherein the heat transfer member comprises a thermally expandable material having a thermal expansion initiation temperature of 90 to 150° C.

9. The battery module of claim 8, wherein the thermally expandable material is a thermally expandable capsule that comprises an outer shell material made of a thermoplastic resin and an internal filler filled in the outer shell material and vaporized by heating.

10. The battery module of claim 9, wherein the outer shell material of the thermally expandable capsule comprises a nitrile-based polymer.

11. The battery module of claim 9, wherein the internal filler of the thermally expandable capsule comprises a C3-C24 volatile saturated hydrocarbon.

12. The battery module of claim 8, wherein the thermal expandable material is included in 3 to 20% by volume compared to a total volume of the heat transfer member.

13. The battery module of claim 8, further comprising:
a cooling member provided on one side of the battery case; and
a heat transfer member interposed between the cooling member and the battery case.

14. The battery module of claim 8, further comprising:
one or more heat insulating members between the plurality of battery cells.

15. A battery module, comprising:
a stack composed of a plurality of battery cells;
a battery case covering the other surfaces of the stack except for one surface of the stack;
a heat transfer member provided on one surface of the stack; and
a cooling member provided on one side of the heat transfer member,
wherein the heat transfer member comprises a thermally expandable material having a thermal expansion initiation temperature of 90 to 150° C.

16. The battery module of claim 15, wherein the thermally expandable material is a thermally expandable capsule that comprises an outer shell material made of a thermoplastic resin and an internal filler filled in the outer shell material and vaporized by heating.

17. The battery module of claim 16, wherein the outer shell material of the thermally expandable capsule comprises a nitrile-based polymer.

18. The battery module of claim 16, wherein the internal filler of the thermally expandable capsule comprises a C3-C24 volatile saturated hydrocarbon.

19. The battery module of claim 15, wherein the thermal expandable material is included in 3 to 20% by volume compared to a total volume of the heat transfer member.

20. The battery module of claim 15, further comprising:
one or more heat insulating members between the plurality of battery cells.
